(19) United States
(12) Patent Application Publication
(10) Pub. No.: US 2025/0054486 A1
(43) Pub. Date: Feb. 13, 2025

(54) SOUND SYNTHESIZER FOR VIRTUAL ENVIRONMENTS

(71) Applicant: Tencent America LLC, Palo Alto, CA (US)

(72) Inventor: Feng SU, Guelph, CA (US)

(73) Assignee: Tencent America LLC, Palo Alto, CA (US)

(21) Appl. No.: 18/447,883

(22) Filed: Aug. 10, 2023

(51) Int. Cl. G10K 15/02; G06T 7/20; G06T 7/60; G06T 13/00

(52) U.S. Cl. CPC G10K 15/02; G06T 7/20; G06T 7/60; G06T 13/00; G06T 2210/16; G06T 2210/36

(57) ABSTRACT

A plurality of motion parameters is determined from a simulated object mesh. The plurality of motion parameters indicates movement speed information of a virtual character, a deformation rate of an object, and a deformation region size of the object. Based on a first audio parameter control and the plurality of motion parameters, a friction sound is obtained from a friction audio database that includes a plurality of sample friction sounds. The first audio parameter control is configured to control characteristics of the friction sound. Based on a second audio parameter control and the plurality of motion parameters, a crumpling sound is obtained from a crumpling audio database that includes a plurality of sample crumpling sounds, and the second audio parameter control is configured to control characteristics of the crumpling sound.

### TECHNICAL FIELD

The present disclosure describes embodiments generally related to synthesizing sounds for simulated physical objects in virtual environments.

### BACKGROUND

The background description provided herein is for the purpose of generally presenting the context of the disclosure. Work of the presently named inventor, to the extent the work is described in this background section, as well as aspects of the description that may not otherwise qualify as prior art at the time of filing, are neither expressly nor impliedly admitted as prior art against the present disclosure.

The past few decades have seen remarkable advances in creating realistic visual effects for computer animations and games. However, to enable a more fully immersive experience for these computer-generated realities, it is also important to incorporate the sense of hearing through sounds, which provide important functions to increase human perception of the virtual world. For example, environmental sounds are often used to set the atmosphere and pace of a scene, and digital audio effects are used to provide feedback to a player's actions in a video game.

### SUMMARY

Aspects of the disclosure include methods, apparatuses, and non-transitory computer-readable storage mediums for sound synthesis. In some examples, an apparatus for sound synthesis includes processing circuitry.

According to an aspect of the disclosure, a method of simulating sound of an object generated by motion of a virtual character is provided. In the method, a plurality of motion parameters associated with the motion is determined from a simulated object mesh. The plurality of motion parameters indicates movement speed information of the virtual character, a deformation rate of the object, and a deformation region size of the object. Based on a first audio parameter control and the plurality of motion parameters, a friction sound is obtained from a friction audio database, where the friction audio database includes a plurality of sample friction sounds associated with the motion of the virtual character. The first audio parameter control is configured to control characteristics (e.g., a pitch or a volume) of the friction sound. Based on a second audio parameter control and the plurality of motion parameters, a crumpling sound is obtained from a crumpling audio database, where the crumpling audio database includes a plurality of sample crumpling sounds associated with deformation of the object, and the second audio parameter control is configured to control characteristics (e.g., a pitch and a volume) of the crumpling sound.

In an example, the movement speed information of the virtual character includes a plurality of movement speeds (e.g., average sliding speeds), a deformation rate of the object indicates a total buckling energy, and a deformation region size of the object indicates a buckling region size. In an example, the first audio parameter control is a first real-time parameter control (RTPC), such as a speed RTPC (e.g., a friction speed RTPC). The second audio parameter control is a second RTPC. The second RTPC can include a crumpling size RTPC and a crumpling intensity RTPC.

In some embodiments, the object includes one of a piece of cloth, a rope, and hair of the virtual character.

In an example, to determine the plurality of motion parameters, vertex information of a plurality of vertices of the simulated object mesh is extracted. The vertex information includes vertex positions and vertex normals of the plurality of vertices.

In an example, to extract the vertex information, based on the simulated object mesh being generated by a CPU-based simulator, the vertex positions and the vertex normals of the plurality of vertices are extracted from a CPU skinned mesh render. Each of the vertex positions is converted from local coordinates to world coordinates. Whether each of the vertex normals is normalized according to a preset standard is further determined.

In an example, to extract the vertex information, based on the simulated object mesh being generated by a GPU-based simulator, the vertex positions and the vertex normals are extracted from level of detail (LOD) render data.

In an embodiment, the movement speed information includes the plurality of movement speeds (e.g., the plurality of average sliding speeds). To determine the plurality of motion parameters, bone positions of a plurality of bones of the virtual character associated with the motion are determined. One or more closest vertices of the plurality of vertices associated with each of the bone positions are determined. Each of the plurality of movement speeds is determined based on a respective bone position and the one or more closest vertices corresponding to the respective bone position.

In an embodiment, to determine the plurality of motion parameters, a mean curvature around each of the plurality of vertices is calculated. The deformation rate associated with the plurality of vertices is determined based on the mean curvatures of the plurality of vertices.

In an example, to determine the plurality of motion parameters, the deformation region size (e.g., buckling region size) is determined based on a total number of the plurality of the vertices used to calculate the mean curvatures.

In an example, to form the friction audio database, the plurality of sample friction sounds associated with the motion of the virtual character is recorded. The plurality of sample friction sounds is grouped into a plurality of sub-containers based on characteristics of the plurality of sample friction sounds. The plurality of sub-containers is stored in a looping random container in the friction audio database.

In an example, to form the crumpling audio database, the plurality of sample crumpling sounds associated with the motion of the virtual character is recorded. The plurality of sample crumpling sounds is grouped into a plurality of sub-containers based on intensities of the plurality of sample crumpling sounds. The plurality of sub-containers is stored in a discrete blend container according to a preset order in the crumpling audio database.

In an example, the second RTPC further includes a crumpling intensity control configured to select which one of the plurality of sub-containers in the crumpling audio database to play based on an intensity level of the deformation rate, and a crumpling size control configured to control a volume of the plurality of sample crumpling sounds.

In an embodiment, a correlation between the first audio parameter control (e.g., a speed RTPC) and the movement speed information (e.g., the plurality of movement speeds) of the virtual character is determined. The friction sound is further extracted from the friction audio database based on the first audio parameter control.

In an embodiment, a first correlation between the deformation rate and the crumpling intensity control is determined. A second correlation between the deformation region size and the crumpling size control is also determined. The crumpling sound is extracted from the crumpling audio database based on the crumpling intensity control and the crumpling size control.

According to another aspect of the disclosure, an apparatus is provided. The apparatus has processing circuitry. The processing circuitry can be configured to perform any one or a combination of the methods for simulating sound of an object that is generated by motion of a virtual character.

Aspects of the disclosure also provide a non-transitory computer-readable medium storing instructions which when executed by at least one processor cause the at least one processor to perform any one or a combination of the methods for simulating sound of an object that is generated by motion of a virtual character.

### BRIEF DESCRIPTION OF THE DRAWINGS

Further features, the nature, and various advantages of the disclosed subject matter will be more apparent from the following detailed description and the accompanying drawings in which:

FIG. 1 is a schematic illustration of an exemplary procedural cloth sound synthesizer in accordance with some embodiments.

FIG. 2 is a schematic illustration of an exemplary motion driver in accordance with some embodiments.

FIG. 3 is an illustration of an exemplary sound synthesizer in accordance with some embodiments.

FIG. 4 shows a flow chart outlining an exemplary process for sound simulation according to some embodiments of the disclosure.

FIG. 5 is a schematic illustration of a computer system in accordance with an embodiment.

### DETAILED DESCRIPTION OF EMBODIMENTS

In the disclosure, BP can stand for blueprint visual scripting. CSS can stand for concatenative sound synthesis. FPS can stand for frames per second. LERP can stand for linear interpolation. LOD can stand for level of detail. PCG can stand for procedural content generation. RC can stand for random container. RTPC can stand for real-time parameter control. The RTPC is configured to control specific properties of various objects in real time based on real-time parameter changes that occur within a game. The objects can be Wwise objects, such as sounds, containers, control busses, effects, and so on. For example, in a racing game, a volume and a pitch of engine sounds of a car can be controlled based on a speed of the car and revolutions per minute (RPM) of the engine. UE5 can stand for Unreal Engine 5. Wwise can stand for wave works interactive sound engine.

In a first related example, a data-driven system is provided to generate sounds for physics-based cloth animations using concatenative sound synthesis (CSS). The synthesis process can contain two steps. In a first step, motions of a cloth animation can be analyzed, and two parametric sound models (e.g., friction and crumpling) can be used to generate an initial low-quality target sound. In a second step, a CSS-based synthesis process is used, which can select a sequence of microsound units from a pre-recorded cloth sound database. The sequence of microsound units can then be concatenated together to match a target sound from the first step. However, the mapping process between the first step and the second step may rely on an experienced sound designer who can provide a plurality of manual correspondences between the target sound and a database sound. Although high fidelity sounds can be rendered for cloth animations, the solution of the first related example requires slow simulation time (e.g., 0.5 to 4 hours), lengthy manual correspondence (e.g., the solution may take around 5 to 15 minutes, with 2 to 5 iterations), and is limited to a small number of given animations. Thus, the solution is difficult to be directly applied to real-time applications, such as games.

In a second related example, a simplified data-driven system is provided using a different set of trade-offs to generate clothing sounds that are capable of real-time synthesis for video games. Similar to the above-mentioned approach in the first related example, the solution of the second related example may also use a friction and crumpling sound model and a manual feature warping technique to drive the synthesis of cloth sounds from real recordings. Instead of generating a low-quality target sound at first, a number of simplified sound models can be used. Although, the number of simplified sound models may output less accurate parameters, the simplified sound models can directly drive a concatenative synthesis of a recorded database. A manual feature correspondence process according to the second related example can use a user-defined warp function that requires fewer parameters to specify. Moreover, the manual feature correspondence process may not involve a sound designer, or the sound designer may only be needed once (within minutes), and can be reused for a same type of cloth. Computation time associated with the second related example can be significantly reduced (e.g., from 0.5 to 6.45 ms). However, there are some compromises on the final sound qualities, most noticeably on transitions between different sound units. Furthermore, the synthesizer in the second related example may be built on a particle-based cloth simulator which may only run in a CPU and may not synthesize sounds for more complicated interactions such as character clothing Additionally, a frictional contact model in the second related example may only calculate an average speed of all contact particles, and a crumpling energy model in the second related example may only consider a single aggregate buckling event. Thus, the solution of the second related example may be less accurate for highly complex interactions. Finally, an interface for a parameter tuning process is not included in the second related example. Therefore, users may not easily customize the sounds based on needs and figure out “best” (or most suitable) possible results.

In the disclosure, data-driven system is provided to synthesize sounds for simulated physical objects. The data-driven system may synthesize sounds in real-time in some aspects. The simulated physical objects include physical-based object simulations in a virtual environment. In an example, the physically-based object may include cloth that is worn by a character in the virtual environment, such as in a video game. For a given object simulator, such as a CPU/GPU-based cloth simulator, the system can use a cloth motion driver to automatically analyze a geometric shape of a piece of cloth (or a piece of clothing) and extract a number of sound-producing motion parameters to drive the synthesis. The sound-producing motion parameters can be extracted at each frame for example. Then, a cloth synthesizer can be used to map the sound-producing motion parameters to corresponding sound clips from a pre-recorded database so that a final cloth audio can be rendered in real time. Compared to the solutions in the first related example or the second related example, the system of the disclosure can be computationally faster while limiting compromises to the sound quality. The solution of the disclosure can also help sound designers to be more efficient by reducing the amount of labor-intensive manual work used in related methods, such as a Foley-based method.

In an aspect, methods and/or systems of the disclosure can be applied to any types of simulated objects which can produce friction and/or crumpling events, such as virtual environments in games that use cloth simulations. Aspects of the disclosure can be applied to certain types of simulated objects, such as non-rigid-body objects. The methods and/or systems of the disclosure can also be extended to work with games and other virtual environments that use other objects that generate sounds based on similar sound producing characteristics as cloth, such as rope and hair simulations that require audio outputs corresponding to the rope and hair simulations. For example, the audio system of the disclosure can be implemented with the unreal engine 5 (UE5) environment in a form of blueprint function (BP) library, where users can easily create game objects inside any character class.

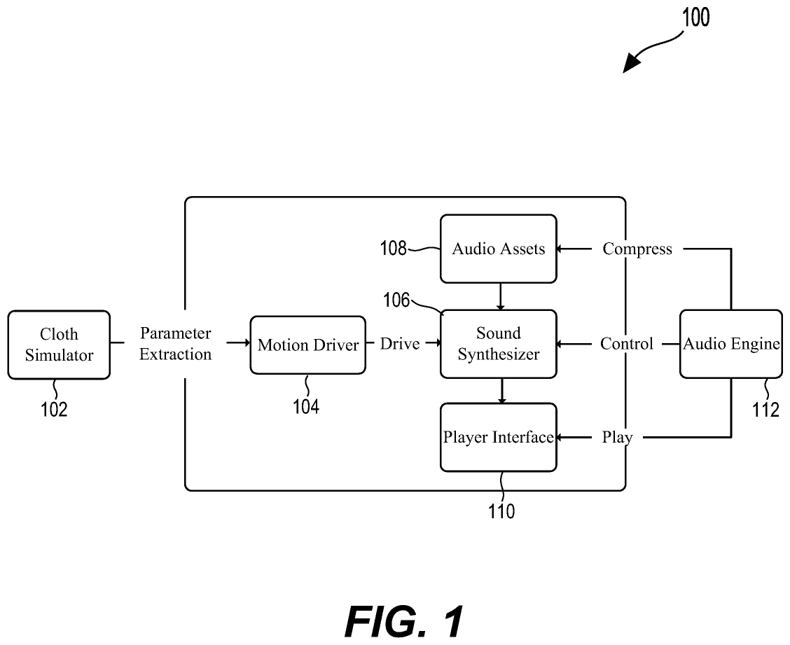

An exemplary goal of the disclosure is to design and implement a data-driven audio system, such as a real-time data-driven audio system, for object (e.g., cloth, rope, hair) simulations. The real-time data-driven audio system can be capable of automatically and efficiently synthesizing audio based on control parameters from the simulation. A main framework of an audio system (100) can be shown in FIG. 1. As shown in FIG. 1, the audio system (or system) (100) can include a cloth simulator (102) configured to generate a simulated cloth mesh (or clothing mesh). In an example, the cloth simulator (102) can be a CPU-based simulator. In an example, the cloth simulator (102) can be a GPU-based simulator. In another example, the cloth simulator (102) can be a software-based simulator. The system (100) can include a motion driver (104). The motion driver (104) can be configured to perform a geometric analysis on the simulated cloth mesh at runtime (or real time). For example, the motion driver (104) can extract vertex information (e.g., vertex positions and vertex normals) of the simulated cloth mesh. The motion driver (104) can further output several parametric sound models (or motion related parameters) to drive the sound synthesis. The system (100) can include a sound synthesizer (106) that can automatically detect sound producing events based on the reported parameters (e.g., the motion related parameters from motion driver (104)) and control the playback of a cloth audio assets (108) from an audio engine (112). Still referring to FIG. 1, the system (100) can include the audio assets (108) that can store sample sounds, such as friction sounds, crumpling sounds, or the like. The audio engine (112) can be any suitable audio engine, such as Wwise, FMOD, SoLoud, or the like. The audio engine (112) can be configured to compress the sample sounds in the audio assets (108), control the sound synthesis in the sound synthesizer (106), and control a player interface (110) to playback the synthesized sounds generated in the sound synthesizer (106).

In an embodiment, the friction sound can include sound that is generated by surface friction of the object (e.g., cloth). The surface friction can be triggered by a motion (e.g., dancing, jumping, or running) of a virtual character (e.g., a person or an animal) in a virtual environment (e.g., a game). The crumpling sound can include sound that is generated by surface deformation of the object. The surface deformation of the object can be triggered by the motion of the virtual character in the virtual environment. It should be noted that different materials or different styles of the object can result in different friction sounds or different crumpling sounds. For example, a pitch or a volume of the friction sound can be affected by a material (e.g., cotton or nylon) or a style (e.g., shirt, T-shirt, or dress) of a piece of clothing.

It is noted that the cloth simulator (102), the motion driver (104), the sound synthesizer (106), the audio assets (108), the player interface (110), and the audio engine (112) can be implemented by one or more software modules, hardware modules, or a combination thereof. A software module (e.g., computer program) may be developed using a computer programming language, and the software module can be executed by one or more processors to perform the functionalities of the software module. A hardware module may be implemented using processing circuitry and/or memory to perform the functionality.

Compared to the first and second related examples, the system (100) in FIG. 1 can use a more efficient processing pipeline to calculate the motions (e.g., dancing, running, jumping), which can significantly increase a computational speed and consumes less memory and CPU power. The system (100) can also be easier for sound designers to use by offering a more user-friendly interface with meaningful parameters to control characteristics of the sounds. Furthermore, the system (100) can separate the audio system from both the cloth simulator (e.g., (102)) and the audio engine (e.g., (112)), making the system (100) more modular and adaptable to various physics engines (e.g., UE5 Chaos) and audio engines (e.g., Wwise).

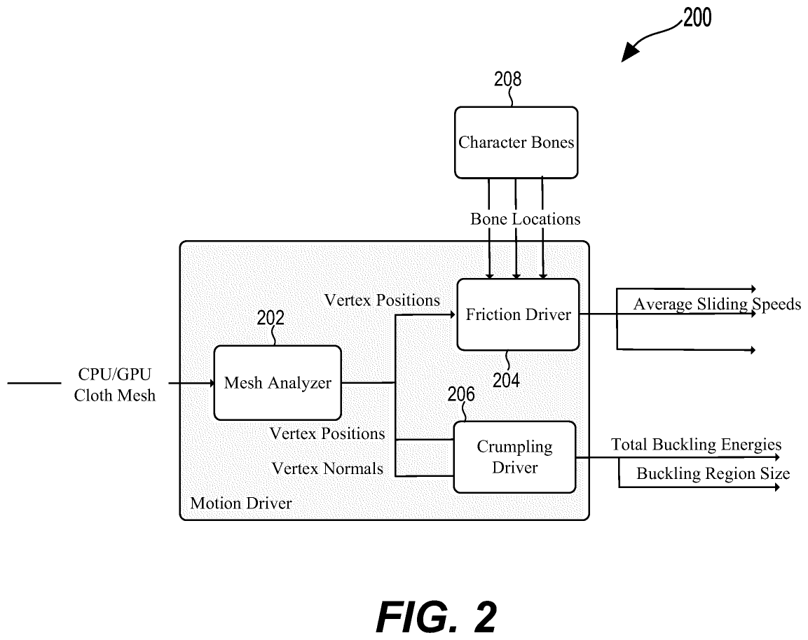

FIG. 2 shows an exemplary motion driver (200) of the disclosure. In an example, the motion driver (200) can be similar to the motion driver (104) in the system (100). As shown in FIG. 2, the motion driver (200) can include three main components: a mesh analyzer (202), a friction driver (204), and a crumpling driver (206). In some embodiments, the motion driver (200) can further include a character bones analyzer (208). The character bones analyzer (208) can be configured to identify bone locations of a character.

Still referring to FIG. 2, the mesh analyzer (202) can extract vertex information that is relevant to the motion analysis. In the second related example, such vertex information is usually stored in a pre-defined function that can be called from a simulator. For example, all vertex positions can be accessed using a particle location function from the VICODynamics cloth simulation plugin that runs on the CPU only. However, not all simulators can provide such functions (e.g., UE5 Chaos). Therefore, to increase the generality of the system (100), the mesh analyzer (202) can be designed to work with both CPU and GPU-based cloth simulation. For CPU-based simulators, vertex information is usually stored in a CPU skinned mesh renderer that can be directly accessed by the analyzer. The vertex information can include both vertex positions and vertex normals. In some embodiments, an extra step can be applied to convert all positions to their corresponding world transform. For example, the extra step can convert the vertex positions from local coordinates to world coordinates. The local coordinates can indicate coordinate values around the character and the world coordinates can indicate coordinate values in the whole game environment. The extra step can also ensure all normals are properly normalized. In an example, the normals can be ensured to be normalized to a preset value (or preset standard) according to an ensuring function of the simulator. For GPU-based simulators, the vertex information can be accessed from a LOD render data. The mesh analyzer (202) can scan for all clothing data from any thread, and then extract simulated cloth data (or clothing data) and output the corresponding data positions, normals and transforms (e.g., the transformation from local coordinates to world coordinates).

Further, two drive models can be introduced to analyze the relevant sound producing motions from the cloth (or clothing). As shown in FIG. 2, the friction driver (204) and the crumpling driver (206) can be applied to analyze the relevant sound producing motions. In a related real-time system, a friction driver can use a position-based collision analysis to calculate the average speed of all contacting vertices. A size of the contact region is also used as another feature. However, this method may only work for a simple shaped cloth (or clothing) such as a square shape or a rectangle shape with fewer vertices (e.g., less than 1000). For a complex cloth (or clothing) on a character such as a dress, the related system may fail to prove that a single set of parameters would be sufficient to approximate all the pitch/volume changes. Moreover, if ray-casting is involved to detect such collisions, the computation can become expensive when a total vertex number exceeds 1000.

In the disclosure, the friction driver (204) can address the mentioned-above issues of the related system by pose of a character (e.g., in a character in a virtual environment), for example by utilizing bone locations of the character, and detecting sliding contact events of an object for which sound is to be synthesized only around a portion of the character, such as around a specific bone (e.g., a bone associated with the motion). For example, a sound designer would be able to specify which portion of or bones on the character would be the most relevant for sound synthesis. The most relevant portion may be identified based on which portion of the character makes the most contact with the cloth (or clothing).

In an example, bone locations can be provided to the friction driver (204) through the character bones analyzer (208). Then, locations of the bones associated with the motion of the character at each frame can be used to find closest vertices on the cloth based on a user-defined delta distance. Next, an average contacting speed between a bone (or bone region) and mesh vertices that contact the bone region can be calculated with a backward difference scheme (e.g., a backward difference function). In some embodiments, an average position of all contacting vertices of the bone region can be used to calculate the average contacting speed.

For simplicity, a contact region size parameter is not extracted in some examples because actual perceptual differences between large and small sliding events may be minor. Accordingly, an audio database construction process in a subsequent step (e.g., in the sound synthesizer) can be simplified.

The crumpling driver (206) can measure changes of the cloth mesh (or clothing mesh). The changes may be measured at each frame. Further, the measured change can include curvature changes in the cloth mesh. A total buckling energy can be calculated by estimating (or calculating) a mean curvature around each vertex in the cloth mesh using a surface triangulation method, and then summing up an energy change of each vertex that has a sign change between two frames for the mean curvature. Thus, each vertex can have a respective buckling energy when the mean curvature of the respective vertex has a sign change between two frames. A sum of the buckling energies of the vertices can be equal to the total buckling energy shown in FIG. 2. The total buckling energy can indicate a deformation rate (or deformation degree) of the cloth. A size of the buckling region can also be used as a feature parameter to drive the synthesis of the sound. The buckling region size can indicate a deformation region size of the cloth.

To improve the performance of the system (100), one or more optimization methods can be added. In a first optimization method, a restriction can be added to prevent the calculated mean curvature from going out of bounds (or limitations) at an edge of the cloth mesh, which may lead to an abnormal total energy. In a second optimization method, a vertex resolution scale factor can be added to control a total number of mesh vertices that need to be calculated at each frame. Depending on a hardware setup, the two optimization methods can effectively increase a computation speed since the crumpling driver (206) can be the most expensive component in the entire system (100).

As shown in FIG. 2, in the case of synthesizing sounds generated by cloth, the mesh analyzer (202) of the motion driver (200) can receive the simulated cloth mesh, and then extract the vertex positions and vertex normals of the cloth mesh. The mesh analyzer (202) can be configured to extract the vertex positions and vertex normals of other object meshes in other examples. The vertex positions can be provided to the friction driver (204). The friction driver (204) can further receive pose information, such as bone locations, of the character from the character bones analyzer (208). Based on the vertex positions and the bone locations, the friction driver (204) can generate movement speed information such as an average sliding speed (or movement speed) for each bone that is associated with the motion of the character. The vertex positions and the vertex normals can also be sent to the crumpling driver (206). The crumpling driver (206) can subsequently generate crumpling information such as a total buckling energy and a buckling region size based on the received vertex positions and vertex normals.

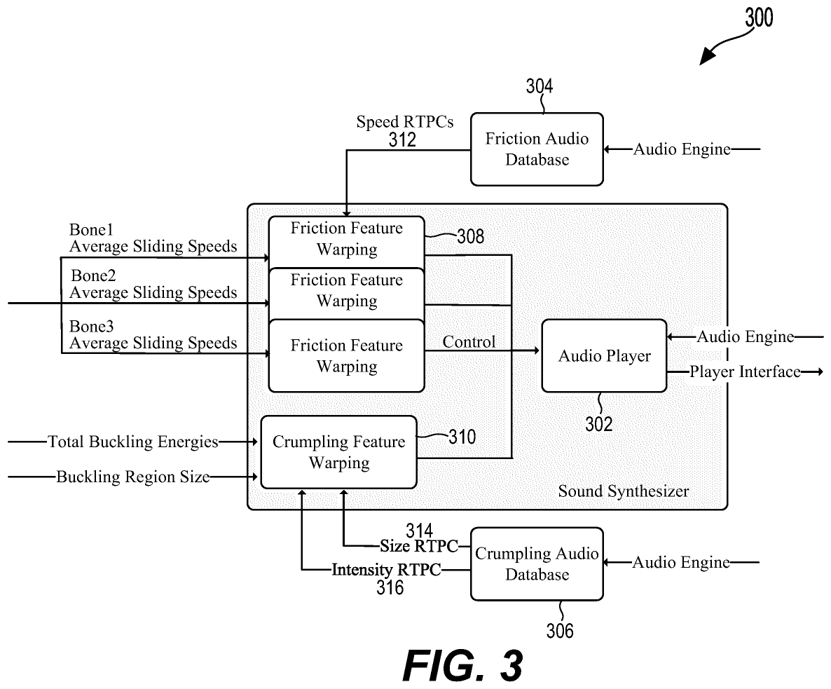

FIG. 3 shows an exemplary sound synthesizer (300). In an example, the sound synthesizer (300) and the sound synthesizer (106) can have same configurations. As shown in FIG. 3, the sound synthesizer (300) can include four main components: an audio database asset, an audio parameter control, such as a real-time parameter control (RTPC), a friction and crumpling feature correspondence, and an audio player (302). The audio database asset can further include a friction audio database (304) and a crumpling audio database (306). The friction audio database (304) can store sample friction sounds, which may be associated with the motion of the character. The crumpling audio database (306) can store sample crumpling sounds, which may be associated with the motion of the character or deformation of the object (e.g., cloth, rope, or hair).

The RTPC can be configured to control playback of sounds extracted from the audio database. For example, the RTPC can control a pitch and/or a volume of sound that is extracted from the audio database. The RTPC can include a plurality of speed (or friction speed) RTPCs (312), a size (or crumpling size) RTPC (314) and an intensity (or crumpling intensity) RTPC (316). The speed RTPCs (312) can be configured to control playback characteristics (e.g., a pitch or a volume) of friction sounds based on movement speed information of the character. The size RTPC (314) can be configured to control playback characteristics (e.g., a volume) of crumpling sounds based on a buckling region size. The intensity RTPC (316) can be configured to control playback characteristics (e.g., a pitch) of the crumpling sounds based on the buckling energy, such as an intensity level of the buckling energy. The friction and crumpling feature correspondence can include a plurality of friction feature warping (308) and a crumpling feature warping (310). The friction feature warping (308) can map the average sliding speeds to the speed RTPCs (312) based on a warping function or a lerp function. The crumpling feature warping (310) can map the size RTPC (314) to the buckling region size and map the intensity RTPC (316) to the total buckling energy.

A lerp function can indicate a linear interpolation. The lerp function can be commonly used to find a point some fraction of a way along a line between two endpoints. The lerp allows a user to interpolate linearly between two values. It can be specified using a minimum and maximum value (a & b) and an interpolation value (t), the interpolation value (t) returns a point on the scale between a and b. The lerp function, mathematically, can be defined as lerp (a,b,t)=a+(b−a)*t, for example.

Still referring to FIG. 3, the audio database (e.g., the friction audio database (304) and the crumpling audio database (306)) can contain pre-recorded cloth friction and crumpling sound clips. In the first and second related examples, the database construction process can be cumbersome and require building a number of apparatuses which adds more labor. In an example, a mechanical roller may be used to record the friction sounds. According to the example, a first sample of cloth is wrapped around the roller, and a second sample of cloth is held against the first sample of cloth. The roller is spun and the friction sounds are recorded. In an example, two custom metal handles may be used to record crumpling sounds. According to the example, a square of cloth is mounted on the two metal handles, and the cloths can be deformed manually using an up-and-down shearing motion to produce crumpling sounds without friction sounds. Further, each type of friction sound may need to be recorded for three different contact region sizes with various speeds, and each type of crumpling sound may need to be recorded using three different cloth (or clothing) sizes with various intensities. The post-processing step can also involve a number of complex data segmentation and labeling. All processed sound units are then stored in a large matrix.

To simplify the construction process of the audio database, a modified recording method can be used in the system (100). One or more audio databases may be configured to store certain types of sounds. A survey can be conducted, with experienced audio designers for example, and based on results of the survey, certain types of sounds for the modified recording method can be used in the system (100).

In an example of the friction audio database (304), a number of sliding movements (or sample friction sounds) can be recorded at first. The sound clips associated with the sliding movements can be grouped. The grouped sound clips can be put into several random sub-containers (e.g., RC_A, RC_B, etc.). Another looping random container can be used to enclose all of these sub-containers, where each container can be cross faded with another with a pre-set duration.

In an example of the crumpling audio database (306), a number of cloth crumples (or sample crumpling sounds) can be recorded at first. The cloth crumples can then be grouped into a random sub-container. The cloth crumples can be grouped based on different intensities of the cloth crumples (e.g., RC_Low, RC_Med, and RC_High). A discrete blend container can be used to store these sub-containers in a specific order (e.g., from low to high intensity). Audio parameter controls (e.g., the RTPCs) can be added to directly control the playback of recorded sounds from these databases. The audio parameter controls may be used to enable control of specific properties of objects within the virtual environment based on parameter changes that occur within the virtual environment, including changes to a character in the virtual environment. The specific properties of the objects may be controlled in real time based on real-time parameter changes in some examples. Further post-processing is not required but may be performed in some aspects. While RTPC is used as an example for audio parameter controls in the disclosure, other audio parameter controls may be utilized.

Next, to create correspondence information (or correlations) with the parametric sound models (e.g., the average sliding speeds, the total buckling energy, and the buckling region size) from the motion drivers, several RTPCs (e.g., (312), (314), and (316)) can be utilized to control playback of recorded sounds in the audio database (e.g., (304) and (306)). For the friction audio database (304), the friction speed RTPCs (312), such as in a range from 0 to 100, can be created to control a pitch and a volume of friction sounds for each bone. In an example, each speed RTPC can control a friction sound associated with a respective bone. For the crumpling audio database (306), the crumpling intensity RTPC (316) can be created to select which crumpling random container (RC) to play based on an input intensity level of the total buckling energy, and the crumpling size RTPC (314) can be used to control a volume of the output crumpling sounds based on the buckling region size.

Table 1 shows exemplary values and functions of the RTPCs of the disclosure. For example, as shown in Table 1, the friction speed RTPC can have a value from 0 to 100. The friction speed RTPC can modify the friction volume in a range from −200 dB to 0 dB and the friction pitch in a range from −300 Cents to 300 Cents.

TABLE 1
Exemplary values and functions of the RTPCs

| | RTPC | | |
|---|---|---|---|
| RTPC Name | Value | Modified Property | Modified Property Value |
| Friction Speed | 0-100 | Friction Volume | −200 dB-0 dB |
| | | Friction Pitch | −300 Cents-300 Cents |
| Crumpling | 0-100 | Crumpling RCs | RC_Low-RC_High |
| Intensity | | | |
| Crumpling Size | 0-100 | Crumpling Volume | −200 dB-0 dB |

An important function of the sound synthesizer (300) is the feature correspondence process, which maps the parameters (e.g., the average sliding speeds, the total buckling energy, and the buckling region size) from the motion drivers to the corresponding RTPCs, or other audio parameter controls, to control the audio playback. For a friction motion, a lerp friction function (or a warping friction function) included in the friction feature warping (308) can be applied to map the average sliding speeds to the speed RTPCs (312). The lerp friction function (or the warping friction function) can specify a minimum sliding speed and a maximum sliding speed, or choose different intensities based on regions of the cloth mesh. For example, the lerp function can warp each input average sliding speed around a specific bone into a space of the friction speed RTPCs (312). A user can then specify the minimum sliding speed and maximum sliding speed to filter out undesired motions. A speed interpolation time can also be set to fine-tune a duration during which the speed RTPCs (312) are changed towards a new value. The speed RTPCs (312) can accordingly control the playback of the friction sounds extracted from the friction audio database (304).

For a crumpling motion, a lerp crumpling function (or a warping crumpling function) can be adopted in the crumpling feature warping (310), which can map the total cloth buckling energy to the intensity RTPC (316) and the cloth buckling region size to the size RTPC (314). Minimum and maximum values for both inputs (e.g., total buckling energy and buckling region size) can also be set by users to filter out idle motions. Thus, the lerp crumpling warping function may be configured to map the total buckling energy to the intensity RTPC (316) and map the buckling region size to the size RTPC (314). The intensity RTPC (316) and the size RTPC (314) can accordingly control the playback of the crumpling sounds extracted from the crumpling audio database (306) based on the total buckling energy and the buckling region size. These feature warping techniques (e.g., the friction feature warping (308) and the crumpling feature warping (310)) can effectively provide a real-time feedback to the audio player (302), resulting in a higher-quality and more accurate cloth audio that corresponds well to different motions on the cloth (or clothing). Depending on the software engine (e.g., game engine) used, controls based on the feature warping techniques can be implemented with different player interfaces. For example, in UE5, a BP library can be integrated to play and control the cloth audio on a character.

In the disclosure, a procedural audio system is provided that can synthesize cloth sounds automatically based on a pre-recorded audio database and parameters, that may be user-defined. The technical solution of the disclosure does not require expensive physics computations and can improve the related real-time data-driven synthesis with more efficient analysis and better output quality. Compared to the first and second related examples, the system (e.g., system (100)) of the disclosure can provide benefits as follows:
(1) Improved usability: The first related example may require an off-line pre-computation process and a degree of manual intervention. The second related example may require a more complex database construction process, may not have an interface for parameter tuning, and may rely on a custom CPU-based cloth simulator. In contrast, the system of the disclosure requires less manual work, and has a simpler database construction process and more intuitive interface for parameter tuning. Moreover, the system of the disclosure can generate more complex cloth sounds (e.g., character clothing) and can seamlessly work with both CPU and GPU-based cloth solvers.
(2) Increased FPS: The first related example may consume more CPU power and may not be suitable for real-time cloth simulations. The second related example and the system of the disclosure can run in real time. To further compare the frames per second (FPS), both the system of the second related example and the system of the disclosure were implemented using a same dress style (3908 vertices) on a dancing character with a same audio database. The average FPS for the system of the second related example was 25.78, and the average FPS for the system of the disclosure was 50.83 on an AMD Ryzen 3970X 32-Core 3.70 GHz CPU and a NVIDIA GeForce RTX 3080 GPU.
(3) More accurate motion: The system of the disclosure can detect friction motions based on bones locations, and compute more efficient crumpling events that isolate edge cases. The second related example may only estimate events based on the average parameters of the entire cloth (or clothing). The related second example may work for a simple square-shaped cloth (or clothing) but may be less accurate for a more complex cloth (or clothing) on a character.
(4) Better sound quality: The synthesis process in the second related example may be based on CSS, in which transitions between sound units are typically ignored or poorly implemented. The system of the disclosure can offer sound designers more flexibility and controls to edit, tune, and adjust source recordings directly inside the audio engine by only manipulating the RTPCs, or other audio parameter controls, to control the actual audio synthesis and playback. The quality of the cloth sound can be greatly improved as a result.

It should be noted that the disclosure may not be limited to the embodiments provided in FIGS. 1-3. The disclosure can include embodiments as follows.
(1) Procedural sound synthesizer for other types of objects in virtual environments, video games, and other simulations using a similar motion and data driven approach, which includes but is not limited to rope, hair, and other types of soft bodies.
(2) Motion driver that contains different components and output parameters, such as an aerodynamic driver that may be used to drive the synthesis of the wind sound produced by the object.
(3) Sounds synthesizer that uses different warping functions or feature correspondence techniques. The sounds synthesizer can be customizable, and therefore can be easily substituted with different solutions, but an important concept is to dynamically map the motion parameters to the control parameters from the audio database.
(4) Audio database can use different construction processes and control parameters but lead to a similar audio asset structure.

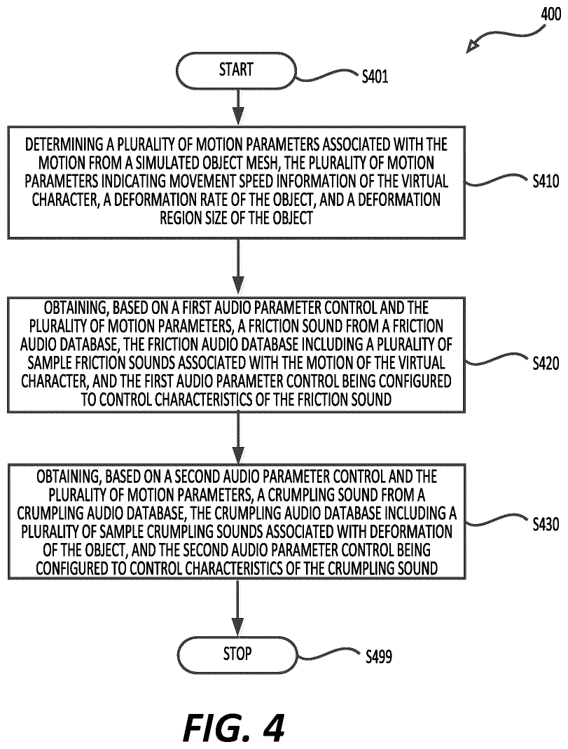

FIG. 4 shows a flow chart outlining a process (400) for sound simulation according to an embodiment of the disclosure. The process starts at (S401) and proceeds to (S410).

At (S410), a plurality of motion parameters associated with the motion is determined from a simulated object mesh. The plurality of motion parameters indicates movement speed information of the virtual character, a deformation rate of the object, and a deformation region size of the object.

At (S420), based on a first audio parameter control and the plurality of motion parameters, a friction sound is obtained from a friction audio database, where the friction audio database includes a plurality of sample friction sounds associated with the motion of the virtual character. The first audio parameter control is configured to control characteristics (e.g., a pitch or a volume) of the friction sound.

At (S430), based on a second audio parameter control and the plurality of motion parameters, a crumpling sound is obtained from a crumpling audio database, where the crumpling audio database includes a plurality of sample crumpling sounds associated with deformation of the object, and the second audio parameter control is configured to control characteristics (e.g., a pitch and a volume) of the crumpling sound.

In an example, the movement speed information of the virtual character includes a plurality of movement speeds (e.g., average sliding speeds), a deformation rate of the object indicates a total buckling energy, and a deformation region size of the object indicates a buckling region size. In an example, the first audio parameter control is a first real-time parameter control (RTPC), such as a speed RTPC (e.g., a friction speed RTPC). The second audio parameter control is a second RTPC. The second RTPC can include a crumpling size RTPC and a crumpling intensity RTPC.

In some embodiments, the object includes one of a piece of cloth, a rope, and hair of the virtual character.

In an example, to determine the plurality of motion parameters, vertex information of a plurality of vertices of the simulated object mesh is extracted. The vertex information includes vertex positions and vertex normals of the plurality of vertices.

In an example, to extract the vertex information, based on the simulated object mesh being generated by a CPU-based simulator, the vertex positions and the vertex normals of the plurality of vertices are extracted from a CPU skinned mesh render. Each of the vertex positions is converted from local coordinates to world coordinates. Whether each of the vertex normals is normalized according to a preset standard is further determined.

In an example, to extract the vertex information, based on the simulated object mesh being generated by a GPU-based simulator, the vertex positions and the vertex normals are extracted from level of detail (LOD) render data.

In an embodiment, the movement speed information includes the plurality of movement speeds (e.g., the plurality of average sliding speeds). To determine the plurality of motion parameters, bone positions of a plurality of bones of the virtual character associated with the motion are determined. One or more closest vertices of the plurality of vertices associated with each of the bone positions are determined. Each of the plurality of movement speeds is determined based on a respective bone position and the one or more closest vertices corresponding to the respective bone position.

In an embodiment, to determine the plurality of motion parameters, a mean curvature around each of the plurality of vertices is calculated. The deformation rate associated with the plurality of vertices is determined based on the mean curvatures of the plurality of vertices.

In an example, to determine the plurality of motion parameters, the deformation region size (e.g., buckling region size) is determined based on a total number of the plurality of the vertices used to calculate the mean curvatures.

In an example, to form the friction audio database, the plurality of sample friction sounds associated with the motion of the virtual character is recorded. The plurality of sample friction sounds is grouped into a plurality of sub-containers based on characteristics of the plurality of sample friction sounds. The plurality of sub-containers is stored in a looping random container in the friction audio database.

In an example, to form the crumpling audio database, the plurality of sample crumpling sounds associated with the motion of the virtual character is recorded. The plurality of sample crumpling sounds is grouped into a plurality of sub-containers based on intensities of the plurality of sample crumpling sounds. The plurality of sub-containers is stored in a discrete blend container according to a preset order in the crumpling audio database.

In an example, the second RTPC further includes a crumpling intensity control configured to select which one of the plurality of sub-containers in the crumpling audio database to play based on an intensity level of the deformation rate, and a crumpling size control configured to control a volume of the plurality of sample crumpling sounds.

In an embodiment, a correlation between the first audio parameter control (e.g., a speed parameter control) and the movement speed information (e.g., the plurality of movement speeds) of the virtual character is determined. The friction sound is further extracted from the friction audio database based on the first audio parameter control.

In an embodiment, a first correlation between the deformation rate and the crumpling intensity control is determined. A second correlation between the deformation region size and the crumpling size control is also determined. The crumpling sound is extracted from the crumpling audio database based on the crumpling intensity control and the crumpling size control.

Then, the process proceeds to (S499) and terminates.

The process (400) can be suitably adapted. Step(s) in the process (400) can be modified and/or omitted. Additional step(s) can be added. Any suitable order of implementation can be used.

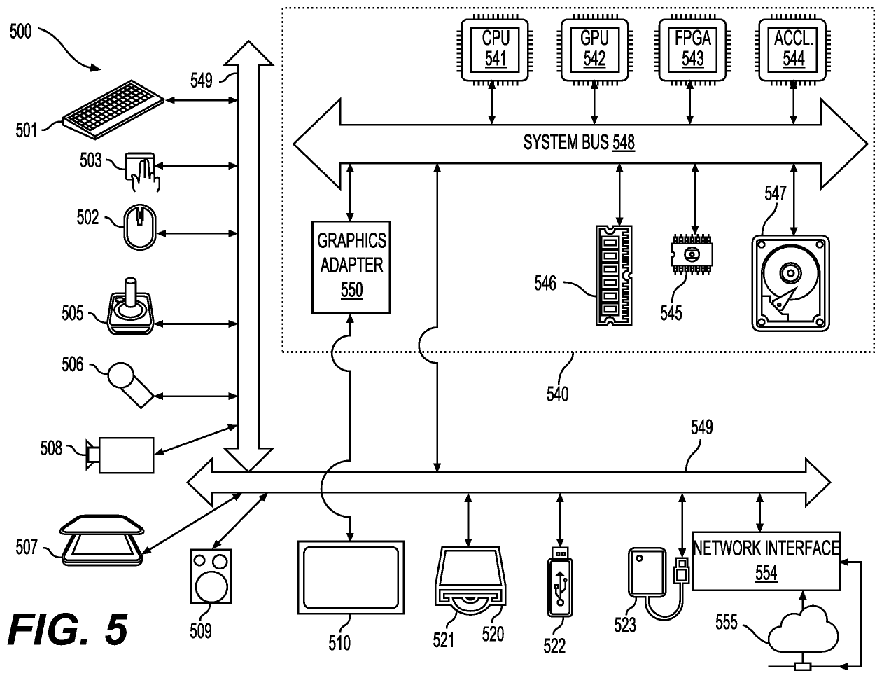

The techniques described above, can be implemented as computer software using computer-readable instructions and physically stored in one or more computer-readable media. For example, FIG. 5 shows a computer system (500) suitable for implementing certain embodiments of the disclosed subject matter.

The computer software can be coded using any suitable machine code or computer language, that may be subject to assembly, compilation, linking, or like mechanisms to create code comprising instructions that can be executed directly, or through interpretation, micro-code execution, and the like, by one or more computer central processing units (CPUs), Graphics Processing Units (GPUs), and the like.

The instructions can be executed on various types of computers or components thereof, including, for example, personal computers, tablet computers, servers, smartphones, gaming devices, internet of things devices, and the like.

The components shown in FIG. 5 for computer system (500) are exemplary in nature and are not intended to suggest any limitation as to the scope of use or functionality of the computer software implementing embodiments of the present disclosure. Neither should the configuration of components be interpreted as having any dependency or requirement relating to any one or combination of components illustrated in the exemplary embodiment of a computer system (500).

Computer system (500) may include certain human interface input devices. Such a human interface input device may be responsive to input by one or more human users through, for example, tactile input (such as: keystrokes, swipes, data glove movements), audio input (such as: voice, clapping), visual input (such as: gestures), olfactory input (not depicted). The human interface devices can also be used to capture certain media not necessarily directly related to conscious input by a human, such as audio (such as: speech, music, ambient sound), images (such as: scanned images, photographic images obtain from a still image camera), video (such as two-dimensional video, three-dimensional video including stereoscopic video).

Input human interface devices may include one or more of (only one of each depicted): keyboard (501), mouse (502), trackpad (503), touch screen (510), data-glove (not shown), joystick (505), microphone (506), scanner (507), camera (508).

Computer system (500) may also include certain human interface output devices. Such human interface output devices may be stimulating the senses of one or more human users through, for example, tactile output, sound, light, and smell/taste. Such human interface output devices may include tactile output devices (for example tactile feedback by the touch-screen (510), data-glove (not shown), or joystick (505), but there can also be tactile feedback devices that do not serve as input devices), audio output devices (such as: speakers (509), headphones (not depicted)), visual output devices (such as screens (510) to include CRT screens, LCD screens, plasma screens, OLED screens, each with or without touch-screen input capability, each with or without tactile feedback capability—some of which may be capable to output two dimensional visual output or more than three dimensional output through means such as stereographic output; virtual-reality glasses (not depicted), holographic displays and smoke tanks (not depicted)), and printers (not depicted).

Computer system (500) can also include human accessible storage devices and their associated media such as optical media including CD/DVD ROM/RW (520) with CD/DVD or the like media (521), thumb-drive (522), removable hard drive or solid state drive (523), legacy magnetic media such as tape and floppy disc (not depicted), specialized ROM/ASIC/PLD based devices such as security dongles (not depicted), and the like.

Those skilled in the art should also understand that term “computer readable media” as used in connection with the presently disclosed subject matter does not encompass transmission media, carrier waves, or other transitory signals.

Computer system (500) can also include an interface (554) to one or more communication networks (555). Networks can for example be wireless, wireline, optical. Networks can further be local, wide-area, metropolitan, vehicular and industrial, real-time, delay-tolerant, and so on. Examples of networks include local area networks such as Ethernet, wireless LANs, cellular networks to include GSM, 3G, 4G, 5G, LTE and the like, TV wireline or wireless wide area digital networks to include cable TV, satellite TV, and terrestrial broadcast TV, vehicular and industrial to include CANBus, and so forth. Certain networks commonly require external network interface adapters that attached to certain general purpose data ports or peripheral buses (549) (such as, for example USB ports of the computer system (500)); others are commonly integrated into the core of the computer system (500) by attachment to a system bus as described below (for example Ethernet interface into a PC computer system or cellular network interface into a smartphone computer system). Using any of these networks, computer system (500) can communicate with other entities. Such communication can be uni-directional, receive only (for example, broadcast TV), uni-directional send-only (for example CANbus to certain CANbus devices), or bi-directional, for example to other computer systems using local or wide area digital networks. Certain protocols and protocol stacks can be used on each of those networks and network interfaces as described above.

Aforementioned human interface devices, human-accessible storage devices, and network interfaces can be attached to a core (540) of the computer system (500).

The core (540) can include one or more Central Processing Units (CPU) (541), Graphics Processing Units (GPU) (542), specialized programmable processing units in the form of Field Programmable Gate Areas (FPGA) (543), hardware accelerators for certain tasks (544), graphics adapters (550), and so forth. These devices, along with Read-only memory (ROM) (545), Random-access memory (546), internal mass storage such as internal non-user accessible hard drives, SSDs, and the like (547), may be connected through a system bus (548). In some computer systems, the system bus (548) can be accessible in the form of one or more physical plugs to enable extensions by additional CPUs, GPU, and the like. The peripheral devices can be attached either directly to the core's system bus (548), or through a peripheral bus (549). In an example, the screen (510) can be connected to the graphics adapter (550). Architectures for a peripheral bus include PCI, USB, and the like.

CPUs (541), GPUs (542), FPGAs (543), and accelerators (544) can execute certain instructions that, in combination, can make up the aforementioned computer code. That computer code can be stored in ROM (545) or RAM (546). Transitional data can also be stored in RAM (546), whereas permanent data can be stored for example, in the internal mass storage (547). Fast storage and retrieve to any of the memory devices can be enabled through the use of cache memory, that can be closely associated with one or more CPU (541), GPU (542), mass storage (547), ROM (545), RAM (546), and the like.

The computer readable media can have computer code thereon for performing various computer-implemented operations. The media and computer code can be those specially designed and constructed for the purposes of the present disclosure, or they can be of the kind well known and available to those having skill in the computer software arts.

As an example and not by way of limitation, the computer system having architecture (500), and specifically the core (540) can provide functionality as a result of processor(s) (including CPU, GPUs, FPGA, accelerators, and the like) executing software embodied in one or more tangible, computer-readable media. Such computer-readable media can be media associated with user-accessible mass storage as introduced above, as well as certain storage of the core (540) that are of non-transitory nature, such as core-internal mass storage (547) or ROM (545). The software implementing various embodiments of the present disclosure can be stored in such devices and executed by core (540). A computer-readable medium can include one or more memory devices or chips, according to particular needs. The software can cause the core (540) and specifically the processors therein (including CPU, GPU, FPGA, and the like) to execute particular processes or particular parts of particular processes described herein, including defining data structures stored in RAM (546) and modifying such data structures according to the processes defined by the software. In addition or as an alternative, the computer system can provide functionality as a result of logic hardwired or otherwise embodied in a circuit (for example: accelerator (544)), which can operate in place of or together with software to execute particular processes or particular parts of particular processes described herein. Reference to software can encompass logic, and vice versa, where appropriate. Reference to a computer-readable media can encompass a circuit (such as an integrated circuit (IC)) storing software for execution, a circuit embodying logic for execution, or both, where appropriate. The present disclosure encompasses any suitable combination of hardware and software.

The use of “at least one of” or “one of” in the disclosure is intended to include any one or a combination of the recited elements. For example, references to at least one of A, B, or C; at least one of A, B, and C; at least one of A, B, and/or C; and at least one of A to C are intended to include only A, only B, only C or any combination thereof. References to one of A or B and one of A and B are intended to include A or B or (A and B). The use of “one of” does not preclude any combination of the recited elements when applicable, such as when the elements are not mutually exclusive.

While this disclosure has described several exemplary embodiments, there are alterations, permutations, and various substitute equivalents, which fall within the scope of the disclosure. It will thus be appreciated that those skilled in the art will be able to devise numerous systems and methods which, although not explicitly shown or described herein, embody the principles of the disclosure and are thus within the spirit and scope thereof.

What is claimed is:

1. A method of simulating sound of an object that is generated by motion of a virtual character, the method comprising:
determining a plurality of motion parameters associated with the motion from a simulated object mesh, the plurality of motion parameters indicating movement speed information of the virtual character, a deformation rate of the object, and a deformation region size of the object;
obtaining, based on a first audio parameter control and the plurality of motion parameters, a friction sound from a friction audio database, the friction audio database including a plurality of sample friction sounds associated with the motion of the virtual character, and the first audio parameter control being configured to control characteristics of the friction sound; and
obtaining, based on a second audio parameter control and the plurality of motion parameters, a crumpling sound from a crumpling audio database, the crumpling audio database including a plurality of sample crumpling sounds associated with deformation of the object, and the second audio parameter control being configured to control characteristics of the crumpling sound.

2. The method of claim 1, wherein the object includes one of a piece of cloth, a rope, and hair of the virtual character.

3. The method of claim 1, wherein the determining the plurality of motion parameters further comprises:
extracting vertex information of a plurality of vertices of the simulated object mesh, the vertex information including vertex positions of the plurality of vertices and vertex normals of the plurality of vertices.

4. The method of claim 3, wherein the extracting the vertex information further comprises:
based on the simulated object mesh being generated by a CPU-based simulator,
extracting the vertex positions and the vertex normals of the plurality of vertices from a CPU skinned mesh render;
converting each of the vertex positions from local coordinates to world coordinates; and
determining whether each of the vertex normals is normalized according to a preset standard.

5. The method of claim 3, wherein the extracting the vertex information further comprises:
based on the simulated object mesh being generated by a GPU-based simulator, extracting the vertex positions and the vertex normals from level of detail (LOD) render data.

6. The method of claim 3, wherein:
the movement speed information includes a plurality of movement speeds; and
the determining the plurality of motion parameters further comprises:
determining bone positions of a plurality of bones of the virtual character associated with the motion,
determining one or more closest vertices of the plurality of vertices associated with each of the bone positions, and
determining each of the plurality of movement speeds based on a respective bone position and the one or more closest vertices corresponding to the respective bone position.

7. The method of claim 3, wherein the determining the plurality of motion parameters further comprises:
calculating a mean curvature around each of the plurality of vertices; and
determining the deformation rate associated with the plurality of vertices based on the mean curvatures of the plurality of vertices.

8. The method of claim 7, wherein the determining the plurality of motion parameters further comprises:
determining the deformation region size based on a total number of the plurality of the vertices used to calculate the mean curvatures.

9. The method of claim 1, further comprising:
recording the plurality of sample friction sounds associated with the motion of the virtual character;
grouping the plurality of sample friction sounds into a plurality of sub-containers based on characteristics of the plurality of sample friction sounds; and
storing the plurality of sub-containers in a looping random container in the friction audio database.

10. The method of claim 1, further comprising:
recording the plurality of sample crumpling sounds associated with the motion of the virtual character;
grouping the plurality of sample crumpling sounds into a plurality of sub-containers based on intensities of the plurality of sample crumpling sounds; and
storing the plurality of sub-containers in a discrete blend container according to a preset order in the crumpling audio database.

11. The method of claim 10, wherein the second audio parameter control further comprises:
a crumpling intensity control configured to select which one of the plurality of sub-containers in the crumpling audio database to play based on an intensity level of the deformation rate, and
a crumpling size control configured to control a volume of the plurality of sample crumpling sounds.

12. The method of claim 11, wherein the obtaining further comprises:
determining a correlation between the first audio parameter control and the movement speed information of the virtual character; and
extracting the friction sound from the friction audio database based on the first audio parameter control.

13. The method of claim 11, wherein the obtaining further comprises:
determining a first correlation between the deformation rate and the crumpling intensity control and a second correlation between the deformation region size and the crumpling size control; and
extracting the crumpling sound from the crumpling audio database based on the crumpling intensity control and the crumpling size control.

14. An apparatus for simulating sound of an object that is generated by motion of a virtual character, the apparatus comprising:
processing circuitry configured to:
determine a plurality of motion parameters associated with the motion from a simulated object mesh, the plurality of motion parameters indicating movement speed information of the virtual character, a deformation rate of the object, and a deformation region size of the object;
obtain, based on a first audio parameter control and the plurality of motion parameters, a friction sound from a friction audio database, the friction audio database including a plurality of sample friction sounds associated with the motion of the virtual character, and the first audio parameter control being configured to control characteristics of the friction sound; and
obtain, based on a second audio parameter control and the plurality of motion parameters, a crumpling sound from a crumpling audio database, the crumpling audio database including a plurality of sample crumpling sounds associated with deformation of the object, and the second audio parameter control being configured to control characteristics of the crumpling sound.

15. The apparatus of claim 14, wherein the object includes one of a piece of cloth, a rope, and hair of the virtual character.

16. The apparatus of claim 14, wherein the processing circuitry is further configured to:
extract vertex information of a plurality of vertices of the simulated object mesh, the vertex information including vertex positions of the plurality of vertices and vertex normals of the plurality of vertices.

17. The apparatus of claim 16, wherein the processing circuitry is further configured to:
based on the simulated object mesh being generated by a CPU-based simulator,
extract the vertex positions and the vertex normals of the plurality of vertices from a CPU skinned mesh render;
convert each of the vertex positions from local coordinates to world coordinates; and
determine whether each of the vertex normals is normalized according to a preset standard.

18. The apparatus of claim 16, wherein the processing circuitry is further configured to:
based on the simulated object mesh being generated by a GPU-based simulator, extract the vertex positions and the vertex normals from level of detail (LOD) render data.

19. The apparatus of claim 16, wherein:
the movement speed information includes a plurality of movement speeds; and
the processing circuitry is further configured to:
determine bone positions of a plurality of bones of the virtual character associated with the motion,
determine one or more closest vertices of the plurality of vertices associated with each of the bone positions, and
determine each of the plurality of movement speeds based on a respective bone position and the one or more closest vertices corresponding to the respective bone position.

20. The apparatus of claim 16, wherein the processing circuitry is further configured to:
calculate a mean curvature around each of the plurality of vertices; and
determine the deformation rate associated with the plurality of vertices based on the mean curvatures of the plurality of vertices.
